(19) United States
(12) Patent Application Publication
(10) Pub. No.: US 2013/0054119 A1
(43) Pub. Date: Feb. 28, 2013

(54) CONTROL SYSTEM FOR COMBUSTION SYSTEM

(71) Applicants: Takamasa YOKOTA, Kariya-city (JP); Satoru Sasaki, Kariya-city (JP); Yoshiaki Nishijima, Toyokawa-city (JP)

(72) Inventors: Takamasa YOKOTA, Kariya-city (JP); Satoru Sasaki, Kariya-city (JP); Yoshiaki Nishijima, Toyokawa-city (JP)

(73) Assignee: Denso Corporation, Kariya-city (JP)

(21) Appl. No.: 13/555,287

(22) Filed: Jul. 23, 2012

(30) Foreign Application Priority Data
Aug. 22, 2011 (JP) 2011-180812

(51) Int. Cl. F02D 41/34; F02D 41/32

(52) U.S. Cl. 701/104; 701/105

(57) ABSTRACT

A control system for a combustion system is applied to a combustion system which has a fuel injector injecting a fuel directly into a combustion chamber and a water injector injecting water (non-combustible fluid) into the combustion chamber. When a combustion engine operates at high load, the water collides with a fuel spray which the fuel injector injects. When a combustion engine operates at low-load, the water injection starts before the fuel injection and the water injection terminates before the fuel injection starts. Thus, the misfire can be avoided and NOx can be decreased by water injection at low-load operation of a combustion engine.

### CROSS-REFERENCE TO RELATED APPLICATION

This application is based on Japanese Patent Application No. 2011-180812 filed on Aug. 22, 2011, the disclosure of which is incorporated herein by reference.

### TECHNICAL FIELD

The present disclosure relates to a control system for a combustion system. In this system, fuel and no-combustible fluid (for example, water) are injected into a combustion chamber of an engine.

### BACKGROUND

JP-9-144606A discloses a system in which fuel and water (non-combustible fluid) are injected into a combustion chamber of an internal combustion engine. In this system, the combustion temperature can be decreased by vaporization latent heat of the injected water, so that the exhaust quantity of Nitrogen Oxide (NOx) during combustion can be decreased.

However, a small amount of fuel is injected when an internal combustion engine operates at low-load. Then, the injected water may lead to a misfire. Therefore, the system above is prohibited to inject the water at low-load operation of an internal combustion engine in order to avoid the misfire. For the reason above, a decrease in NOx by water injection at low-load operation of an internal combustion engine can not be obtained.

### SUMMARY

It is an object of the present disclosure to provide a control system for combustion system in which the misfire can be avoided and NOx can be decreased by water injection at low-load operation of an internal combustion engine.

According to the present disclosure, a combustion system includes: a fuel injector injecting a fuel directly into a combustion chamber of an internal combustion engine; and a non-combustible fluid injector injecting a non-combustible fluid into the combustion chamber. The non-combustible fluid injector injects the non-combustible fluid in such a manner that a non-combustible fluid spray collides with a fuel spray which the fuel injector injects when an internal combustion engine operates at a high-load which is greater than or equal to a predetermined load. On the other hand, the non-combustible fluid injector starts to inject the non-combustible fluid before the fuel injector starts to inject the fuel, and the non-combustible fluid injector terminates to inject the non-combustible fluid before the fuel injector starts to inject the fuel, when an internal combustion engine operates at low-load which is less than predetermined load.

That is, since the non-combustible fluid injector starts to inject the non-combustible fluid before the fuel injector starts to inject the fuel, and the non-combustible fluid injector terminates to inject the non-combustible fluid before the fuel injector starts to inject the fuel, it can be avoided that an injected non-combustible fluid spray collides with an injected fuel spray. Therefore, the misfire can be avoided and NOx can be decreased by non-combustible fluid injection at low-load operation of an internal combustion engine.

However, since an injected non-combustible fluid spray collides with an injected fuel spray at high-load operation of an internal combustion engine, the combustion temperature is decreased by vaporization latent heat of the injected non-combustible fluid, and the effect of decrease in heat loss is improved. More specifically, since an injected non-combustible fluid spray collides with an injected fuel spray, the penetrating force of the fuel spray is decreased so that the fuel spray hardly reaches the cylinder wall surface and piston head. Therefore, the combustion heat transferred to the cylinder wall surface and piston head are reduced and the heat loss of the combustion can be decreased.

In conclusion, since an injected non-combustible fluid spray collides with an injected fuel spray at a high-load operation of an internal combustion engine, the decrease in the combustion temperature (decrease in NOx) by vaporization latent heat of the injected non-combustible fluid can be obtained, and the effect of decrease in heat loss is improved. On the other hand, since the non-combustible fluid injector terminates to inject the non-combustible fluid before the fuel injector starts to inject the fuel at low-load operation of an internal combustion engine, the misfire can be avoided and the decrease in the combustion temperature (decrease in NOx) can be obtained.

### BRIEF DESCRIPTION OF THE DRAWINGS

The above and other objects, features and advantages of the present disclosure will become more apparent from the following detailed description made with reference to the accompanying drawings. In the drawings:

FIG. 1A and FIG. 1B are construction diagrams showing an outline of an engine and a fuel combustion system according to a first embodiment;

FIG. 2A and FIG. 2B are construction diagrams showing a shape and a distribution of fuel spray in a case where the water injector terminates to inject the water before the fuel injector starts to inject the fuel at low-load operation of an internal combustion engine;

FIG. 2C and FIG. 2D are construction diagrams showing a shape and a distribution of fuel spray and water spray in a case where water is injected at a high-load operation of an internal combustion engine;

FIG. 3 is a flowchart showing a procedure of a fuel injection control and a water injection control according to the first embodiment;

FIG. 4A and FIG. 4B are time charts showing a fuel injection command signal and water injection command signal when an internal combustion engine operating at low-load;

FIG. 4C and FIG. 4D are time charts showing a fuel injection command signal and water injection command signal when an internal combustion engine operating at a high-load;

FIG. 5A, FIG. 5B, FIG. 5C, FIG. 5D, FIG. 5E, FIG. 5F, FIG. 5G, FIG. 5H, FIG. 5I and FIG. 5J are charts showing an experiment result according to the first embodiment;

FIG. 6A, FIG. 6B, FIG. 6C, FIG. 6D, FIG. 6E and FIG. 6F are construction diagrams showing outlines of an engine and a fuel combustion system according to a second embodiment;

FIG. 7A is a construction diagram showing an outline of an engine and a fuel combustion system according to a third embodiment;

FIG. 7B is a construction diagram showing a shape and a distribution of fuel spray in a case where the water injector terminates to inject the water before the fuel injector starts to inject the fuel at low-load operation of an internal combustion engine; and

FIG. 7C is a construction diagram showing a shape and a distribution of fuel spray and water spray in a case where water is injected at high-load operation of an internal combustion engine.

### DETAILED DESCRIPTION

Hereafter, embodiments of the present invention will be described. The same parts and components as those in each embodiment are indicated with the same reference numerals and the same descriptions will not be reiterated.

### First Embodiment

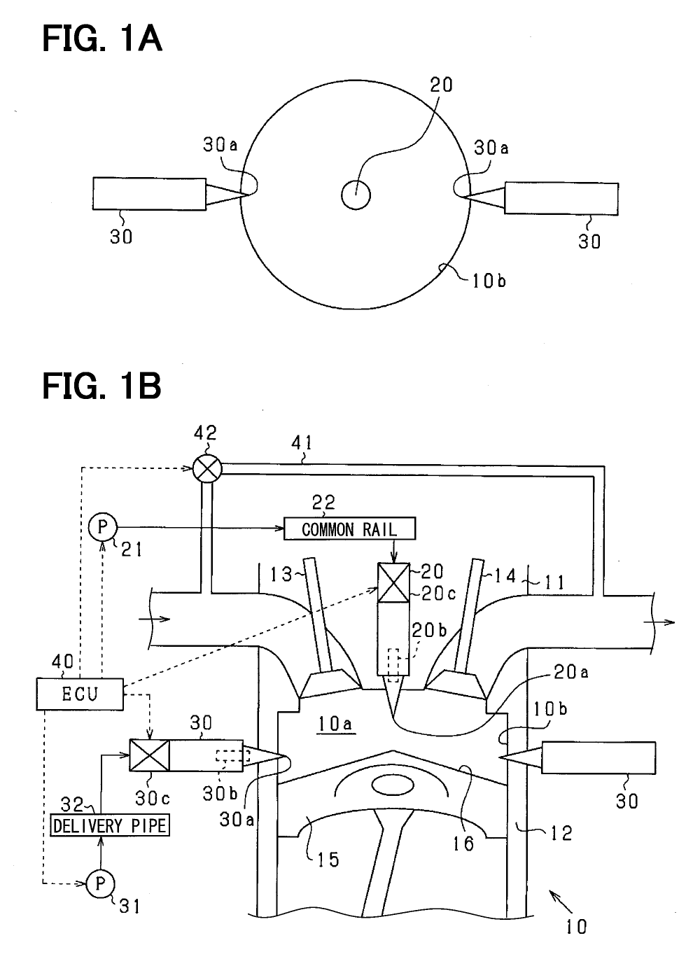

FIG. 1A and FIG. 1B are schematic views showing a combustion system and an internal combustion engine (diesel engine) 10 of compression self-ignition. The engine 10 has an intake valve 13 and an exhaust valve 14.

A fuel injector 20 is provided in a cylinder head 11 of the engine 10, and two water injectors (non-combustible fluid injector) 30 are provided in a cylinder block 12 of the engine 10. FIG. 1A is schematic chart viewed from top of FIG. 1B to show positions of the fuel injector 20 and the water injectors 30.

The fuel injector 20 is inserted into the cylinder head 11 in its axial direction. An injection port 20a is positioned in a combustion chamber 10a. Liquid fuel (for example, light oil) stored in a fuel tank is introduced into a common-rail 22 by a fuel pump 21. The accumulated fuel in the common-rail 22 is supplied to the fuel injector 20. In the present embodiment, the engine 10 has multiple cylinders each of which is provided with the fuel injector 20.

The fuel injector 20 is formed of a body having the injection port 20a, a valve 20b, and an electric actuator 20c. When an electronic control unit (ECU) 40 turns on the actuator 20c, the valve 20b is opened to inject the fuel into the combustion chamber 10a directly. When the ECU 40 turns off the actuator 20c, the valve 20b is closed to terminate the fuel injection.

Two water injectors 30 are inserted into a side wall of the cylinder block 12 in such a manner as to confront each other. Water (non-combustible fluid) stored in a water tank is introduced into a delivery pipe 32 by a water pump 31, and the accumulated high-pressure water in the delivery pipe 32 is supplied to the water injectors 30 provided in each cylinder.

It is preferable that the water supplied to the water injectors 30 is heated by a heater (not shown), such as a heat exchanger of the engine 10 or an electric heater.

Also, the water injector 30 is formed of a body having the injection port 30a, a valve 30b, and an electric actuator 30c. When the ECU 40 turns on the actuator 30c, the valve 30b is opened to inject the water into the combustion chamber 10a directly. When the ECU turns off the actuator 30c, the valve 30b is closed to terminate the water injection.

It will hereinafter be described in detail that the water injection and the fuel injection are conducted at the same time when an internal combustion engine 10 operates at a high-load which is greater than or equal to a predetermined load. On the other hand, the water injectors 30 start to inject water before the fuel injector 20 starts to inject the fuel, and the water injectors 30 terminate to inject water before the fuel injector 20 starts to inject the fuel, when an internal combustion engine operates at low-load which is less than the predetermined load.

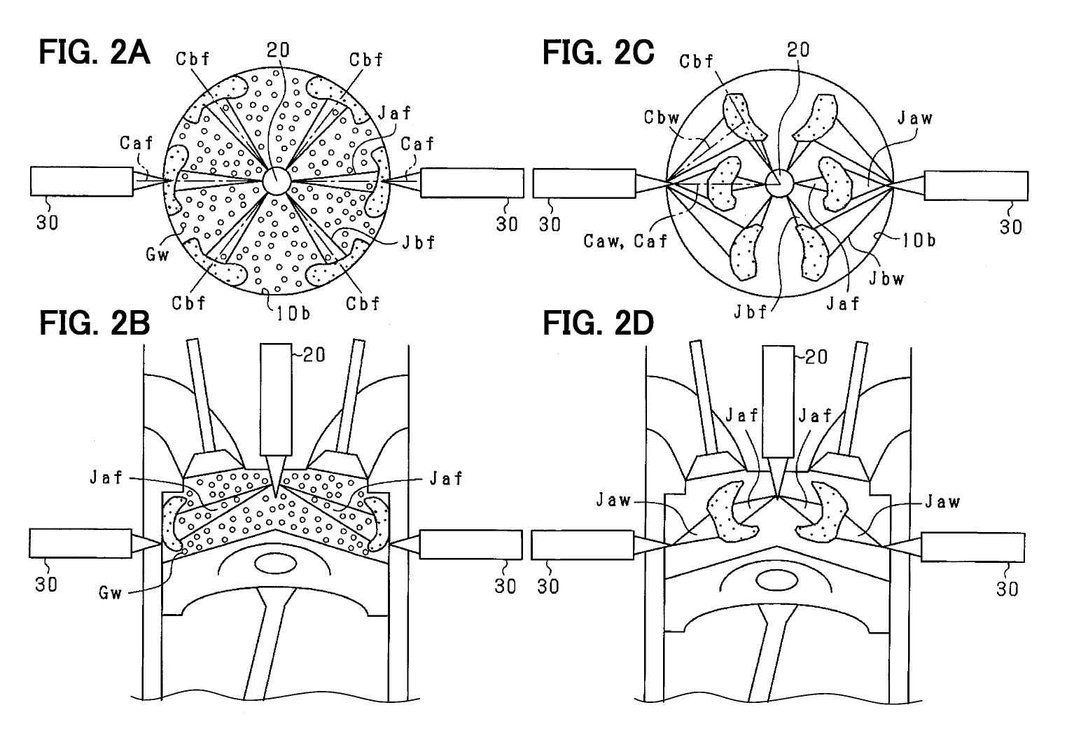

FIGS. 2A and 2B are schematic view showing a case where the water injectors 30 terminate to inject water before the fuel injector 20 starts to inject the fuel from the injection port 20a. Its injected fuel sprays are denoted by “Jaf” and “Jbf” and the vaporized water (evaporative water) injected from the water injectors 30 into the combustion chamber 10 is denoted by “Gw” in FIGS. 2A and 2B. FIG. 2A is a schematic chart viewed from top of FIG. 2B. The fuel injector 20 has six injection ports 20a. A plurality of fuel sprays “Jaf” and “Jbf” are conical shape. Each injection port 20a is arranged equidistantly around a center axis of the fuel injector 20.

FIGS. 2C and 2D are schematic view showing a case where the water injection and the fuel injection are conducted at the same time when an internal combustion engine operates at high-load. The water injector 30 injects the water from the injection port 30a. Its injected water sprays denoted by “Jaw” and “Jbw” and the injected fuel sprays are denoted by “Jaf” and “Jbf” in FIGS. 2C and 2D. The water spray collides with the fuel spray so that the fuel spray flows apart from the cylinder wall surface 10b.

More specifically, the water spray collides with the fuel spray so that flow velocity of the fuel spray toward the cylinder wall surface 10b is attenuated. The fuel spray “Jaf” collides with the water spray “Jaw”. In other words, the fuel injector 20 and the water injectors 30 are arranged in such a manner that a center line “Caf” of the fuel spray “Jaf” coincides with a center line “Caw” of the water spray “Jaw”. Moreover, the fuel spray “Jbf” collides with the water spray “Jbw” from its side direction.

In other words, the fuel injector 20 and the water injectors 30 are arranged in such a manner that a center line “Cbf” of the fuel spray “Jbf” crosses a center line “Cbw” of the water spray “Jbw”. It should be noted that shaded portions in FIGS. 2A to 2D indicate positions where the fuel spray and the water spray collide with each other.

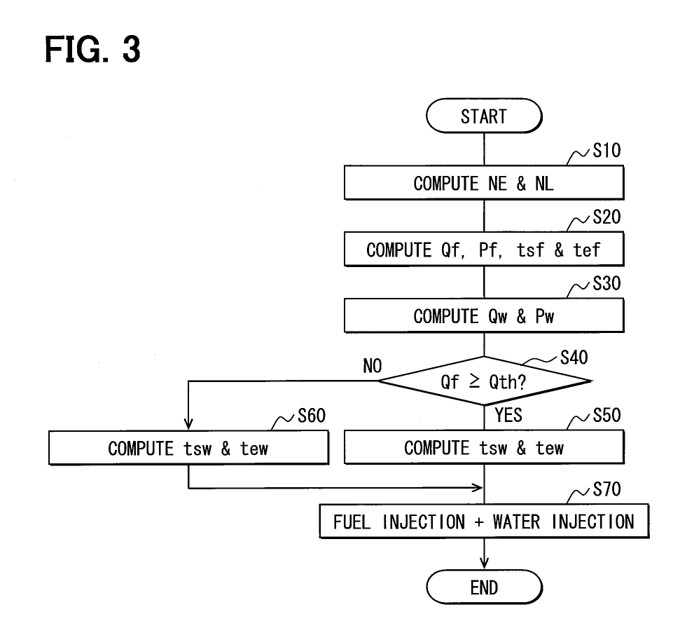

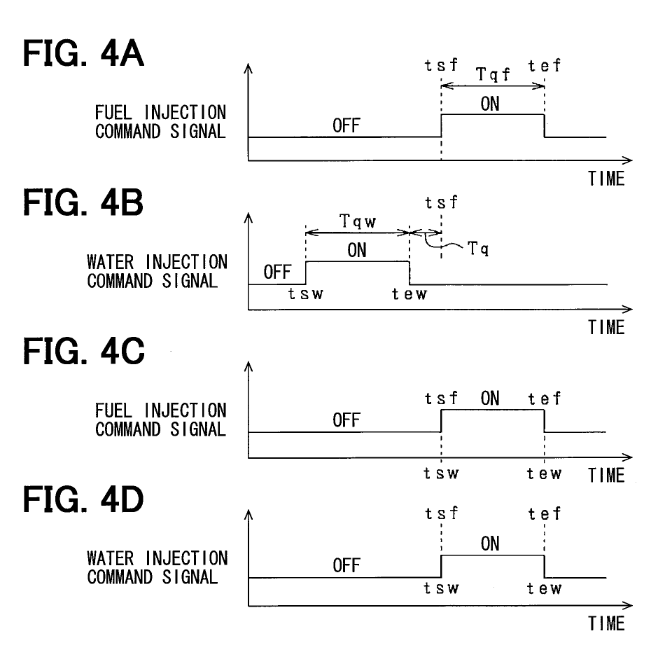

The ECU 40 has a microcomputer including a CPU and a memory to control the fuel injector 20 and the water injectors 30. Specifically, the ECU 40 controls an injection start timing “ts” and an injection period “Tq”. By controlling the injection period “Tq”, an injection quantity “Q” per one injection is controlled. This control will be described later in detail, referring to FIGS. 3 and 4.A to 4.D.

Furthermore, the ECU 40 controls a discharge quantity of the fuel pump 21 and the water pump 31 to control fuel pressure in the common-rail 22 and water pressure in the delivery pipe 32. Specifically, each of the fuel pump 21 and the water pump 31 is a plunger pump with a suction control valve which adjusts a suction quantity of the fuel or the water. The ECU 40 controls this suction control valve so that a fuel supply pressure “Pf” and a water supply pressure “Pw” are obtained.

The ECU 40 receives various detection signals indicative of engine speed NE, an accelerator position, and required engine torque. Based on these detection signals, the ECU 40 controls the fuel injector 20.

FIG. 3 is a flowchart showing a processing of the fuel injection control and the water injection control. This control processing is executed by a microcomputer which the ECU 40 includes. When an ignition switch is turned on, this processing is initiated and is repeated at a specified period of specified crank angle.

In step S10, the computer computes the engine speed “NE” and the required engine load “NL”. In step S20, the computer computes target values of the fuel injection quantity “Qf” and the fuel supply pressure “Pf” based on the engine speed “NE” and the required engine load “NL”.

For example, the optimal fuel injection quantity “Qf” and a fuel-injection-start time “tsf” relative to the engine speed “NE” and the engine load “NL” are previously obtained by experiments. This relationship is stored in a map. In view of this map, the fuel injection quantity “Qf” and the fuel-injection-start time “tsf” are computed. Besides, it is preferable that the fuel injection quantity “Qf” is made larger as the engine load “NL” and the engine speed “NE” becomes higher.

There is a high correlation between an opening period of the valve 20b (injection period Tqf) and the injection quantity “Qf”. A fuel-injection-end time “tef” corresponds to a time after injection period “Tqf” elapsed from the fuel-injection-start time “tsf”. The fuel supply pressure “Pf” is also computed in view of the map. It is preferable that the fuel supply pressure “Pf” is made larger as the engine load “NL” and the engine speed “NE” becomes higher. The ECU 40 controls the discharge quantity of the fuel pump 21 based on a target valve of the fuel supply pressure “Pf”.

In step S30, the computer computes target values of the water injection quantity “Qw” and the water supply pressure “Pw” based on the engine speed “NE” and the required engine load “NL” which are computed in step S10. Specifically, the optimal water injection quantity “Qw” and water supply pressure “Pw” are previously obtained by experiments. This relationship is stored in a map. In view of this map, the water injection quantity “Qw” and the water supply pressure “Pw” are computed. Besides, it is preferable that the water injection quantity “Qw” and the water supply pressure “Pw” are made larger as the engine load “NL” and the engine speed “NE” becomes higher.

Alternatively, the computer can compute target values of the water injection quantity “Qw” and the water supply pressure “Pw” based on the fuel injection quantity “Qf” which is computed in step S20. It is preferable that the water injection quantity “Qw” and the water supply pressure “Pw” are made larger as the fuel injection quantity “Qf” becomes larger.

In step S40, the computer determines whether the computed fuel injection quantity “Qf” is greater than or equal to a specified value “Qth”. When the answer is YES, the internal combustion engine 10 is operating at high-load so that the procedure proceeds to step S50 in which the water-injection-start time “tsw” and the water-injection-end time “tew” are computed.

In step S50 (first control portion), the computer computes the water-injection-start time “tsw” so that the fuel spray “Jaf” and “Jbf” collide with the water spray “Jaw” and “Jbw” as shown in FIG. 2C. Also, the water-injection-end time “tew” is computed based on the water injection quantity “Qw”, the water supply pressure “Pw” and the water-injection-start time “tsw”. However, the water-injection-end time “tew” is restricted to earlier than the fuel-combustion-end time. It is preferable that the water-injection-end time “tew” is restricted to earlier than the fuel-injection-end time “tef”.

When the restriction above is not conducted, because of the water injected after the combustion, the decrease in the combustion temperature (the decrease in NOx) is not obtained and the workload of piston 15 is decreased under the decrease in pressure in the cylinder. Thus, when the restriction above is conducted, it is possible to avoid an unnecessary water-injection and the decrease in the workload of piston.

For example, first, the water-injection-start time “tsw” is set on the fuel-injection-start time “tsf”. Then, the water-injection-end time “tew” is computed based on the water-injection-start time “tsw”, the water injection quantity “Qw” and the water supply pressure “Pw”. Finally, when “tew” is after the fuel-injection-end time “tef”, “tsw” is offset earlier so that “tew” equals to “tef”. Alternatively, “Pw” is increased so that “tew” equals to “tef”.

FIGS. 4C and 4D are time charts showing output times of injection-command signals to the fuel injector 20 and the water injectors 30. In these charts, the water-injection-start time “tsw” is set on the fuel-injection-start time “tsf”, and the water-injection-end time “tew” is set on the fuel-injection-end time “tef”. Thus, the fuel sprays “Jaf” and “Jbf” collide with the water sprays “Jaw” and “Jbw”, and the water injection is prohibited after the combustion terminates.

In step S40, when the answer is NO, the internal combustion engine 10 is operating at low-load so that the procedure proceeds to step S60 in which the water-injection-start time “tsw” and the water-injection-end time “tew” are computed.

In step S60 (second control portion), the computer computes the water-injection-start time “tsw” and the water-injection-end time “tew” so that the fuel spray “Jaf” and “Jbf” avoid from colliding with the water spray “Jaw” and “Jbw”, and the water injection terminates before the fuel injection starts, as shown in FIG. 2A. Specifically, “tsw” and “tew” are computed so that the injected water is completely vaporized before the fuel injection starts.

FIGS. 4A and 4B are time charts showing output times of injection-command signals to the fuel injector 20 and the water injectors 30. For example, first, the vaporization window time “Tg” is computed based on the temperature in the cylinder (for example, engine coolant temperature or exhaust temperature). Then, the water-injection-end time “tew” is set on the time just before a predetermined period of time (vaporization window time “Tg”) than the fuel-injection-start time “tsf”. Finally, the water-injection-start time “tsw” is computed based on “tew”, the water injection quantity “Qw” and the water supply pressure “Pw”.

In step S70, the fuel injector 20 and the water injectors 30 are operated to perform a fuel injection and water injections which satisfy the fuel injection conditions “Qf”, “tsf” and “tef” computed in step S20, and the water injection conditions “Qw”, “tsw” and “tew” computed in step S30, S50 and S60. In addition, the two water injectors are controlled to be operated as the same as each other.

In conclusion, according to the present embodiment, when an internal combustion engine operates at low-load, the water injection terminates before the fuel injection starts so that the misfire can be avoided and NOx can be decreased by water injection.

Since NOx can be decreased by water injection on all operations, the exhaust quantity of NOx can be controlled by the water injection quantity “Qw” so that it is unnecessary to control NOx quantity by controlling EGR quantity. That is, according to the operation of the internal combustion engine, the water injection quantity “Qw” is set to satisfy the decrease in EGR with its target value so that the opening of the EGR valve 42 in EGR pipe 41 can be fixed, for example, 30% of the opening.

Also, when the exhaust quantity of NOx is controlled by EGR quantity, the intake quantity and the supercharging pressure are changed according to the opening variation of EGR valve 42 so that various controls, such as the fuel injection quantity, the time of fuel injection, the supercharging pressure and EGR quantity, become complicated. According to the present embodiment, the opening of the EGR valve 42 is fixed and the exhaust quantity of NOx is controlled by the water injection quantity “Qw” so that the control can be easily attained.

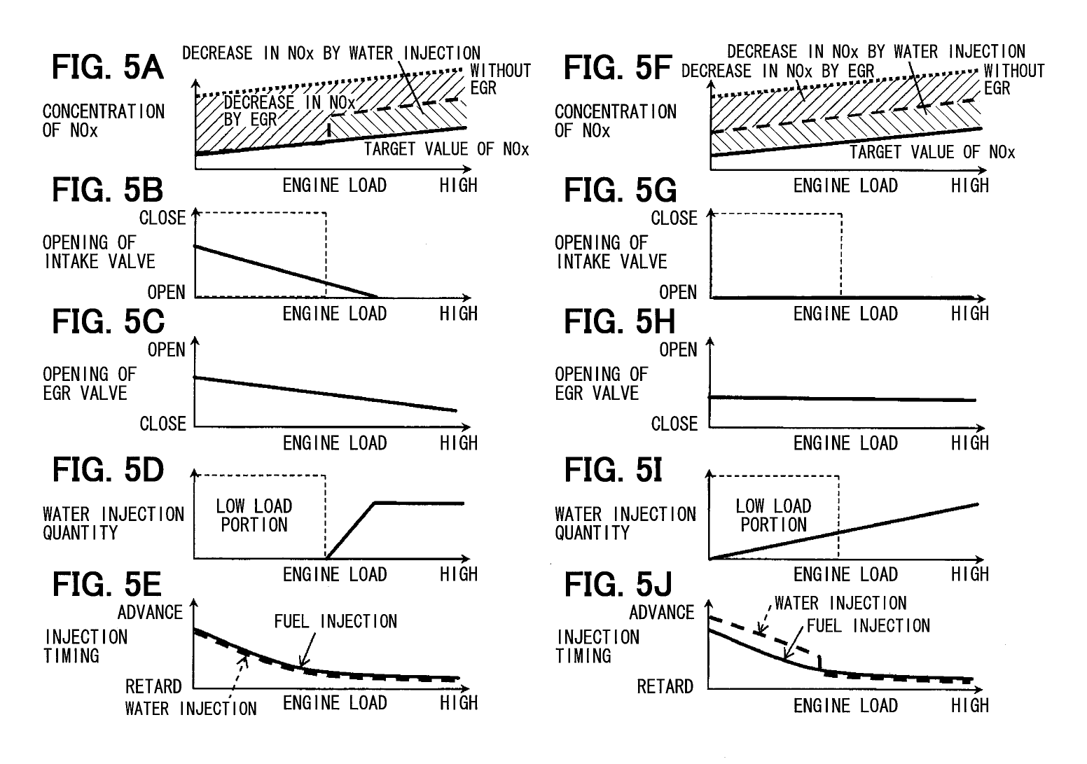

FIGS. 5A to 5J show experiment results according to the description above. FIGS. 5A to 5E show the results of the case where the water injection is prohibited and the misfire is avoid, at low-load operation of the internal combustion engine. On the other hand, FIGS. 5F to 5J show the results of the case where the water injector is operated to perform a water injection which satisfies the conditions computed in step S60 during a low-load operation of the internal combustion engine. In FIGS. 5E and 5J, the solid lines are showing the fuel-injection-start time “tsf” according to the engine load, and the dotted lines are showing the water-injection-start time “tsw”. When “tsw” is set on “tsf” at low-load operation of the internal combustion engine, the combustion becomes unstable so that the water injection can not be conducted, as shown in FIG. 5E. On the other hand, when the water-injection-start time “tsw” is advanced at low-load operation of the internal combustion engine, the instability of the combustion can be avoided and the water injection can be conducted.

FIGS. 5A and 5F show the relationship between the engine load and the concentration of NOx (the exhaust quantity of NOx). The dotted lines show the quantity of NOx when the EGR quantity is zero and the water injection is not conducted, and the solid lines show the target values of the exhaust quantities of NOx. Therefore, the quantity of NOx shown in dotted lines are required to decrease to the target values which are shown in solid lines according to the decrease in NOx by EGR and water injection. The shaded portions indicate the decrease in NOx by EGR, and the halftone dot portions indicate the decrease in NOx by water injection.

Since the water injection is prohibited at low-load operation of the internal combustion engine as shown in FIG. 5A, the EGR quantity is increased as shown in FIG. 5C. The opening of the intake valve becomes smaller when the opening of the EGR valve 42 becomes larger as shown in FIG. 5B so that the necessary quantity of EGR is sure to be recirculated. On the other hand, the opening of the EGR valve 42 can be fixed as shown in FIG. 5H in a case where the water injection can be conducted at low-load operation of the internal combustion engine as shown in FIG. 5F. As a result, the opening variation of the intake valve according to the opening variation of the EGR valve 42 becomes unnecessary.

That is, the water-injection-prohibited control shown in FIGS. 5A to 5E is necessary to control the opening of the EGR valve 42 so that the exhaust quantity of NOx is set on the target value at low-load operation of the internal combustion engine. On the other hand, in water-injection-possible control according to the present embodiment shown in FIGS. 5F to 5J, the opening of the EGR valve 42 can be fixed so that the water injection quantity “Qw” is controlled to satisfy the exhaust quantity of NOx with the target value at low-load operation of the internal combustion engine.

Furthermore, according to the present embodiment, following advantages can be obtained.

(1) Since the water sprays “Jaw” and “Jbw” are formed to collide with the fuel sprays “Jaf” and “Jbf” at high-load operation of the internal combustion engine, a penetrating force of the fuel spray is decreased so that the fuel spray hardly reaches the cylinder wall surface 10b. Thus, the injected fuel is combusted at a position away from the cylinder wall surface 10b, so that the combustion heat transferred to the cylinder wall surface 10b is reduced and the heat loss of the combustion can be decreased. Besides, since the water is injected to collide with the fuel spray, it is expedited that the fuel spray can be well spread in the combustion chamber 10a. Thus, the fuel spray is equally distributed in the combustion chamber 10a, whereby fuel combustion can be ideally conducted.

(2) In a conventional combustion system, a piston has a concave portion on its top surface to generate a tumble flow. Meanwhile, according to the present embodiment, since the fuel spray can be equally distributed in the combustion chamber 10a as described above, it is unnecessary to form a concave portion on a top surface of the piston. The piston 16 has a convex top surface as shown in FIG. 1B.

(3) Since the piston 16 is configured to have a convex top surface, a top dead center of the piston 16 is not restricted with respect to the position of the water injectors 30.

### Second Embodiment

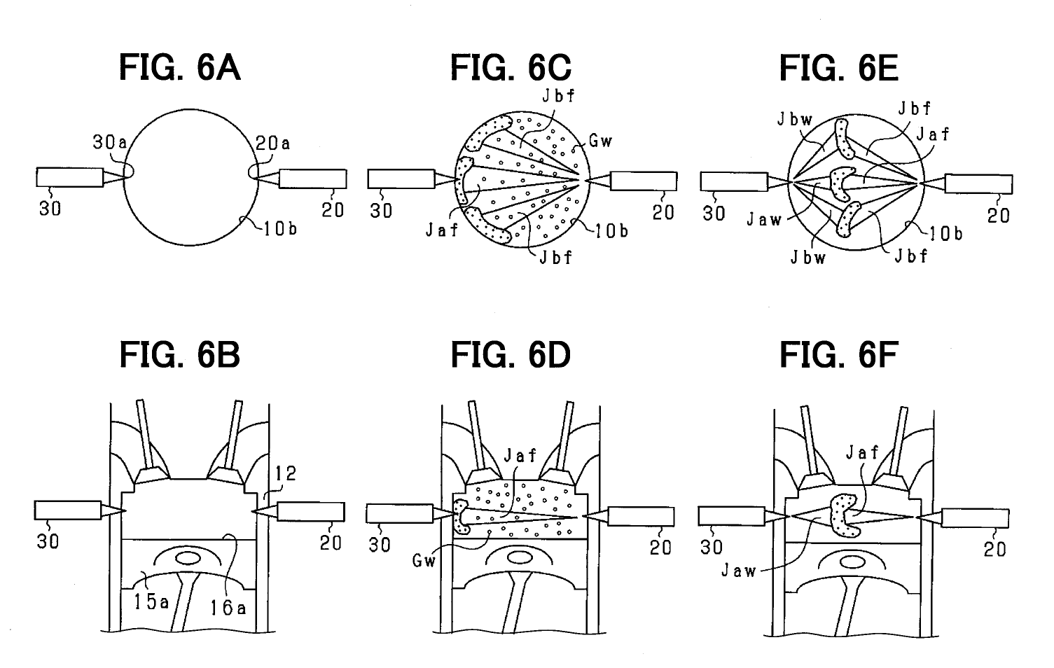

As shown in FIGS. 6A and 6B, the fuel injector 20 is provided in the cylinder block 12 to inject the fuel into the combustion chamber 10a in its radial direction.

FIGS. 6C and 6D are schematic views showing a case where the water injector 30 terminates to inject water before the fuel injector 20 starts to inject the fuel from the injection port 20a at low-load operation of the internal combustion engine. The injected fuel sprays are denoted by “Jaf” and “Jbf” and the vaporized water (evaporative water) injected from the water injector 30 into the combustion chamber 10 is denoted by “Gw” in FIGS. 6C and 6D. FIGS. 6A, 6C and 6E are schematic chart viewed from top of FIGS. 6B, 6D and 6F. The fuel injector 20 has three injection ports 20a. A plurality of fuel sprays “Jaf” and “Jbf” are conical shape. Each injection port 20a is arranged on a same plane.

FIGS. 6E and 6F are schematic views showing a case where the water injection and the fuel injection are conducted at the same time at high-load operation of the internal combustion engine. The water injector 30 injects the water from the injection ports 30a. Its injected water sprays are denoted by “Jaw” and “Jbw” and the injected fuel sprays are denoted by “Jaf” and “Jbf” in FIGS. 6E and 6F. The water spray collides with the fuel spray so that the fuel spray flows apart from the cylinder wall surface 10b.

The fuel spray “Jaf” collides with the water spray “Jaw”. In other words, the fuel injector 20 and the injector 30 are arranged in such a manner that a center line of the fuel spray “Jaf” coincides with a center line of the water spray “Jaw”. Moreover, the water spray “Jbw” collides with the fuel spray “Jbf” from its side direction. In other words, the fuel injector 20 and the water injector 30 are arranged in such a manner that a center line of the fuel spray “Jbf” crosses a center line of the water spray “Jbw”. It should be noted that shaded portions in FIGS. 6E and 6F indicate portions where the fuel spray and the water spray collide with each other.

According to the present embodiment described above, since the water sprays are formed not to collide with the fuel sprays “Jaf” and “Jbw” at low-load operation of the internal combustion engine, the misfire can be avoided and NOx can be decreased by water injection. It is the same advantage as the first embodiment.

### Third Embodiment

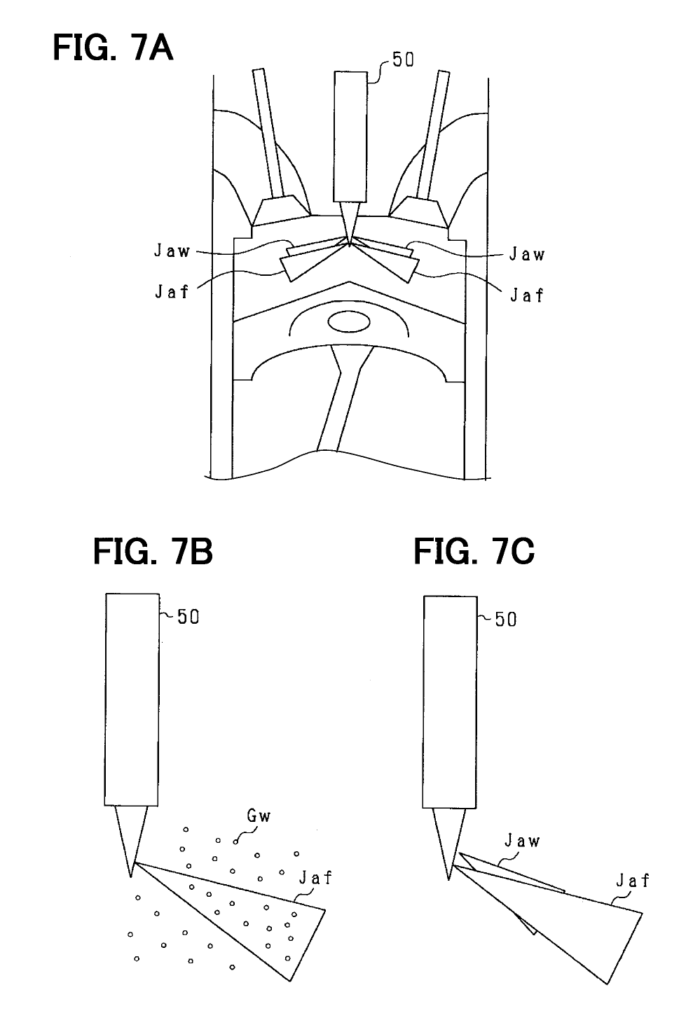

The fuel injector 20 and the water injector(s) 30 are separated according to the first and the second embodiment described above. According to the present embodiment, however, a fuel injection port and a water injection port are arranged on the injector 50 as shown in FIG. 7A so that the number of injectors can be reduced.

Furthermore, the positions of the fuel injection port and the water injection port are necessary to be set in such a manner that the fuel spray “Jaf” collides with the water spray “Jaw” at high-load operation of the internal combustion engine. Besides, it is necessary that the opening-closing of the fuel injection port and the water injection port is controlled independently.

FIG. 7B is a schematic view showing a case where the water injection terminates before the fuel injection starts from the fuel injection port at low-load operation of the internal combustion engine. The injected fuel sprays are denoted by “Jaf” and the vaporized water (evaporative water) injected from the water injection port into the combustion chamber 10 is denoted by “Gw” in FIG. 7B.

FIG. 7C is a schematic view showing a case where the water injection and the fuel injection are conducted at the same time at high-load operation of the internal combustion engine. From the injector 50, the injected water spray is denoted by “Jaw” and the injected fuel spray is denoted by “Jaf” in FIG. 7C. The water spray collides with the fuel spray so that the fuel spray flows apart from the cylinder wall surface 10b.

According to the present embodiment described above, since the water spray is formed not to collide with the fuel spray “Jaf” at low-load operation of the internal combustion engine, the misfire can be avoided and NOx can be decreased by water injection. It is the same advantage as the first embodiment.

### Other Embodiment

The present invention is not limited to the embodiments described above, but may be performed, for example, in the following manner. Further, the characteristic configuration of each embodiment can be combined.

(1) In the first embodiment, the opening of the EGR valve 42 can be variably set based on the operation of the internal combustion engine. In other words, since the decrease in NOx is changed according to the target value of the exhaust quantity of NOx, the decrease in NOx is controlled only by the water injection quantity “Qw”. Thus, the decrease in NOx can be controlled by the opening of the EGR valve 42 and the water injection quantity “Qw”.

(2) In the first embodiment, the water supply pressure “Pw” and the water-injection-start time “tsw” can be changed at the same time so that the water-injection-end time “tew” is set on the time just before the vaporization window time “Tg” than the fuel-injection-end time “tef”.

(3) In the first embodiment, when the load of an internal combustion engine is extremely lower than the specified value “Qth”, for example, idle operation load, the water injection can be inhibited so that the misfire is surely avoided. Thus, the operation of an internal combustion engine can include the low-load mode, the high-load mode and the extreme-low-load mode.

(4) In the first embodiment, the vaporization window time “Tg” can be removed so that the water-injection is set to be terminated before the fuel-injection-start time “tsf”.

(5) In the embodiments above, the water-injection-end time “tew” and the fuel-injection-end time “tef” may deviate from each other at high-load operation of the internal combustion engine. However, it should be noted that the times “tew” and “tef” should be established in order to avoid a situation in which the water does not collide with the fuel spray and a situation in which the fuel does not collide with the water spray.

(6) In the embodiments above, the non-combustible fluid is not limited only to water, for example, it can be carbonated water which contains carbonic acid such as CO2, supercritical water which controlled by high temperature and high pressure in order to be equal to or greater than the critical point, or the water which includes air.

(7) In the embodiments above, the present invention is applied to an internal combustion engine of compression self-ignition. Also, the present invention can be applied to an ignited internal combustion engine in which the fuel is injected directly into the combustion chamber. Furthermore, the present invention is applied to an internal combustion engine of compression self-ignition which is formed to inject the fuel into a pre-combustion chamber that connects the combustion chamber. Besides, it is preferable that the water is injected into the combustion chamber formed by the top of piston 12.

What is claimed is:

1. A control system for a combustion system, comprising:
a fuel injector injecting a fuel directly into a combustion chamber of an internal combustion engine;
a non-combustible fluid injector injecting a non-combustible fluid into the combustion chamber;
a first control portion which controls a non-combustible fluid injection so that a non-combustible fluid spray collides with a fuel spray which the fuel injector injects when the internal combustion engine operates at a high-load which is greater than or equal to a predetermined load; and
a second control portion which controls the non-combustible fluid injection so that the non-combustible fluid injector starts to inject the non-combustible fluid before the fuel injector starts to inject the fuel and the non-combustible injector terminates to inject the non-combustible fluid before the fuel injector starts to inject the fuel when the internal combustion engine operates at a low-load which is less than the predetermined load.

2. A control system for a combustion system according to claim 1, wherein:
the non-combustible fluid injector injects the non-combustible fluid in such a manner that the non-combustible fluid spray is completely vaporized before the fuel injector starts to inject the fuel when the internal combustion engine operates at the low-load.

3. A control system for a combustion system according to claim 1, wherein:
the non-combustible fluid injection quantity is set according to an operation of the internal combustion engine.

4. A control system for a combustion system according to claim 3, further comprising:
an EGR pipe recirculating a part of the exhaust gas from the combustion chamber into an intake pipe; and
an EGR valve controlling an opening of the EGR pipe, wherein:
the EGR valve is fixed to a specified opening so that an exhaust of nitrogen oxide is controlled by the non-combustible fluid injection quantity.

5. A control system for a combustion system according to claim 1, wherein:
the non-combustible fluid injector terminates to inject the non-combustible fluid before the fuel injector terminates to inject the fuel when the internal combustion engine operates at the high-load.
